(19) United States
(12) Patent Application Publication
(10) Pub. No.: US 2006/0082834 A1
(43) Pub. Date: Apr. 20, 2006

(54) Scanners

(75) Inventor: Liu-Zhi Yang, Suzhou (CN)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/223,362

(22) Filed: Sep. 9, 2005

(30) Foreign Application Priority Data
Oct. 19, 2004 (TW) TW93131644

(51) Int. Cl. H04N 1/23

(52) U.S. Cl. 358/296; 358/474

(57) ABSTRACT

Scanner. A scanner for scanning an object comprises a main body, a cover, and a positioning mechanism. The cover is rotatably disposed on the main body. The positioning mechanism is disposed on the main body and the cover. When the cover is open and the object is disposed between the main body and the cover, the object is maintained thereon by the positioning mechanism. When the cover is closed, the cover forces the positioning mechanism to press on the object such that the object is abutted on the main body.

### BACKGROUND

The invention relates to scanners, and in particular to scanners in an upright position while capable of maintaining the object thereon.

Scanners are conventionally placed flat on a desk. When used in an office or home work area, other devices such as displays and printers may also be put in the same space; however, the large planar area of the scanner can occupy excessive workable space. To save space, upright scanners have been developed.

Although upright scanners save space, scanned documents easily tilt and drop out of the scanner. Thus, it is usually inconvenient for most users to scan objects on an upright scanner.

A Taiwan patent publication NO. 529869 has disclosed a scanner to solve this problem. FIG. 1A is a perspective view of a conventional upright scanner 10. FIG. 1B is a local enlarged view of FIG. 1A. FIG. 1C is a side view of the conventional upright scanner 10, showing a partial cut-out view.

As shown in FIGS. 1A to 1C, the conventional upright scanner 10 comprises a housing 1, a transparent glass layer 2, a cover 3, and a base 4. The cover 3 is rotatably connected to the housing 1 via a pivoting structure. The base 4 supports the housing 1 in an upright position. A flange 11 is formed at the intersection of a bottom edge of the transparent glass layer 2 and the housing 1, protruding outward in a direction perpendicular to the transparent glass layer 2 such that a document 5 is abutted at the top of the flange 11. Thus, the document 5 is positioned vertically. As shown in FIG. 1B, the flange 11 has two protrusions 12 formed thereon, protruding upward to restrict lateral disposition of the document 5. Furthermore, a pressing and guiding element 6 is disposed on an inner wall of the cover 3 with a concave shape. The concave face of the pressing and guiding element 6 is curved toward the transparent glass layer 2. The maximum curvature is formed in the middle thereof such that the document 5 can be guided and pressed on the transparent glass layer 2.

However, The disclosed patent has some disadvantages. Since the flange 11 and the protrusions 12 on the edges are integrally formed or rigidly formed on the housing 1, the flange 11 must be shallow and short to prevent interference when closing the cover 3 on the housing 1. Users must carefully aim at the shallow and short flange 11 to position the document 5 thereon. Ensuring the cover placed correctly is tedious and inconvenient. Even if the user carefully positions the document 5 on the flange 11, the document 5 still tends to fall off since the flange 11 is short. Thus, scanning quality is deteriorated if the document 5 is not correctly positioned on the transparent glass layer 2. Moreover, the curved pressing and guiding element 6 on the cover 3 increases the weight and size of the scanner 10, and the cover 3 and the housing 1 cannot be closely combined with a gap formed therebetween due to the curved shape of the pressing and guiding element 6. Thus, the scanner 10 cannot be slim and light.

### SUMMARY

Therefore, an object of the present invention is to provide a scanner. An exemplary embodiment of the scanner for scanning an object comprises a main body, a cover, and a positioning mechanism. The cover is rotatably disposed on the main body. The positioning mechanism is disposed on the main body and the cover. When the cover is open and the object is disposed between the main body and the cover, the object is maintained thereon by the positioning mechanism. When the cover is closed, the cover forces the positioning mechanism to press on the object such that the object is abutted on the main body.

The positioning mechanism comprises a first blocking piece and a first elastic structure, connecting the main body and the first blocking piece. When the cover is open, the first elastic structure tilts the first blocking piece at a first angle with respect to the main body.

The first elastic structure comprises a pivoting structure and an elastic element, encircling the pivoting structure.

The elastic element comprises a spring.

The positioning mechanism further comprises a first pad, disposed on the first blocking piece, and a second pad, disposed on the cover. When the cover is closed on the main body, the first pad and the second pad substantially contact the same side of the object.

The main body comprises a scanning area. When the cover is closed on the main body, the first pad and the second pad completely cover the scanning area of the main body.

The first pad and the second pad comprise sponge or rubber.

The positioning mechanism comprises a second blocking piece and a second elastic structure connecting the second piece and the main body. When the cover is open, the second elastic structure tilts the second blocking piece at a second angle with respect to the main body, preventing the object from sliding down a side of the main body.

The positional mechanism further comprises a first blocking piece, substantially perpendicular to the second blocking piece, and a first elastic structure, connecting the main body and the first blocking piece. When the cover is open, the first elastic structure tilts the first blocking piece at a first angle with respect to the main body.

The positioning mechanism further comprises a third blocking piece and a third elastic structure disposed on an opposite side of the side of the main body and connecting the third blocking piece and the main body. When the cover is open, the third elastic structure tilts the third blocking piece at a third angle with respect to the main body, preventing the object from falling off on the opposite side.

The second elastic structure comprises a pivoting structure and an elastic element, encircling the pivoting structure.

The elastic element comprises a spring.

The positioning mechanism comprises a first blocking piece and a pair of second blocking pieces, disposed in the vicinity of two ends of the first blocking piece. The first blocking piece and the second blocking piece are substantially arranged in a U-shape.

The scanner comprises an upright-type scanner.

### DESCRIPTION OF THE DRAWINGS

Scanners can be more fully understood by reading the subsequent detailed description in conjunction with the examples and references made to the accompanying drawings, wherein:

FIG. 1A is a schematic view of a conventional upright scanner;

FIG. 1B is a local enlarged view of FIG. 1A;

FIG. 1C is a side view of the conventional upright scanner, showing a partial cut-out view;

FIG. 2A is a schematic view of an embodiment of a scanner;

FIG. 2B is a local enlarged view of a first elastic structure of FIG. 2A;

FIGS. 3A to 3D are schematic views of continuous motion of the scanner cover;

FIG. 4 is a schematic view of another embodiment of a scanner;

FIGS. 5A and 5B are local enlarged views of a portion V of FIG. 4 in different views.

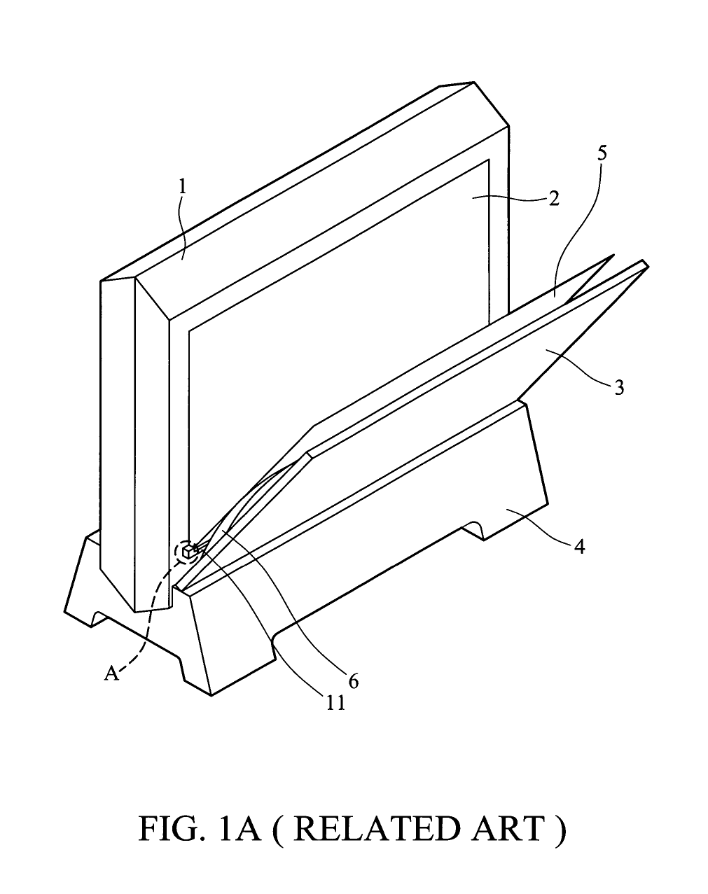

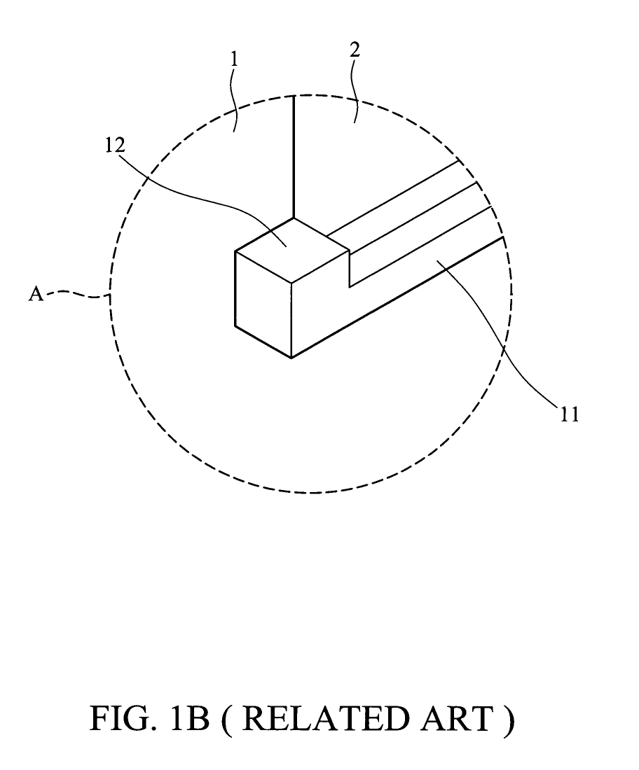

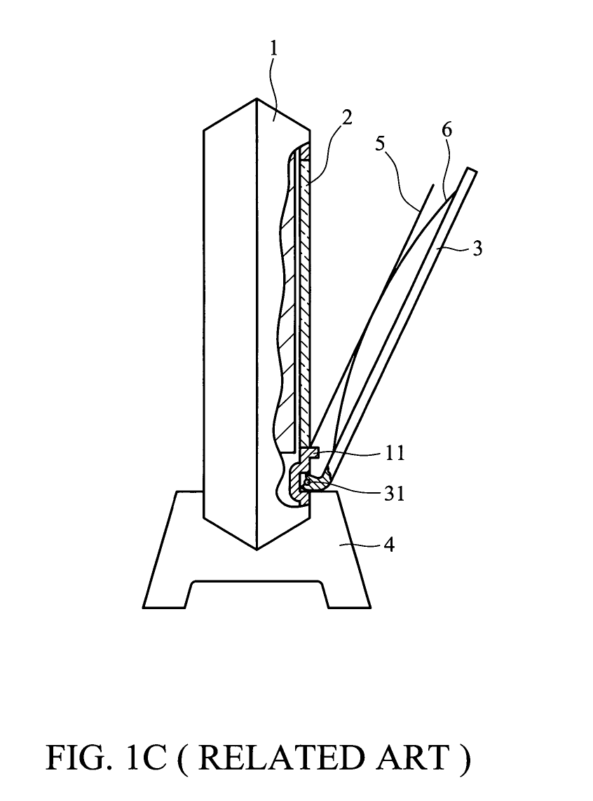

### DETAILED DESCRIPTION

Scanners are provided. An exemplary embodiment of a scanner for scanning an object is disclosed as follows.

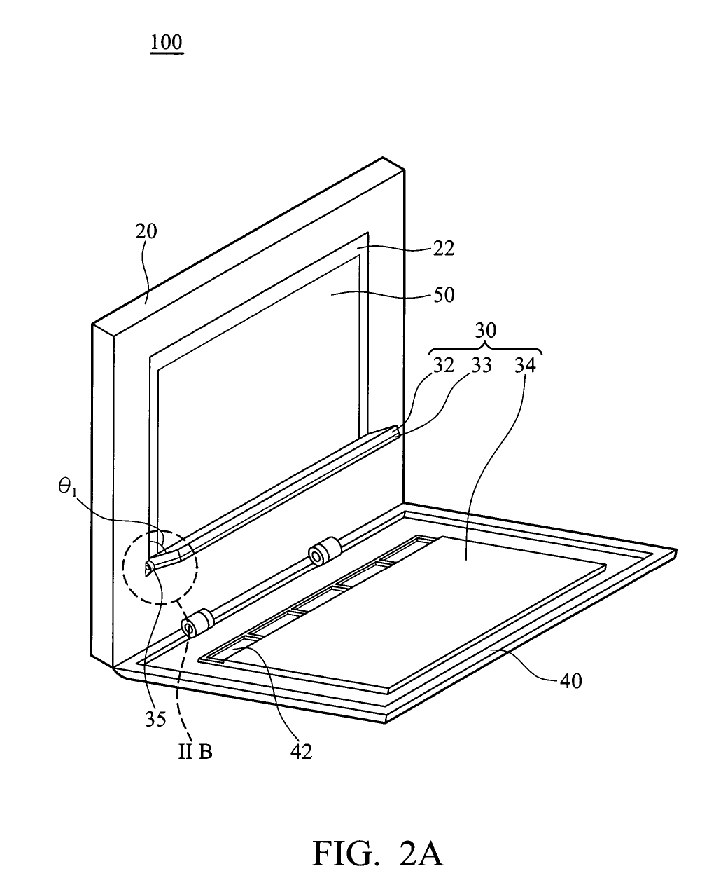

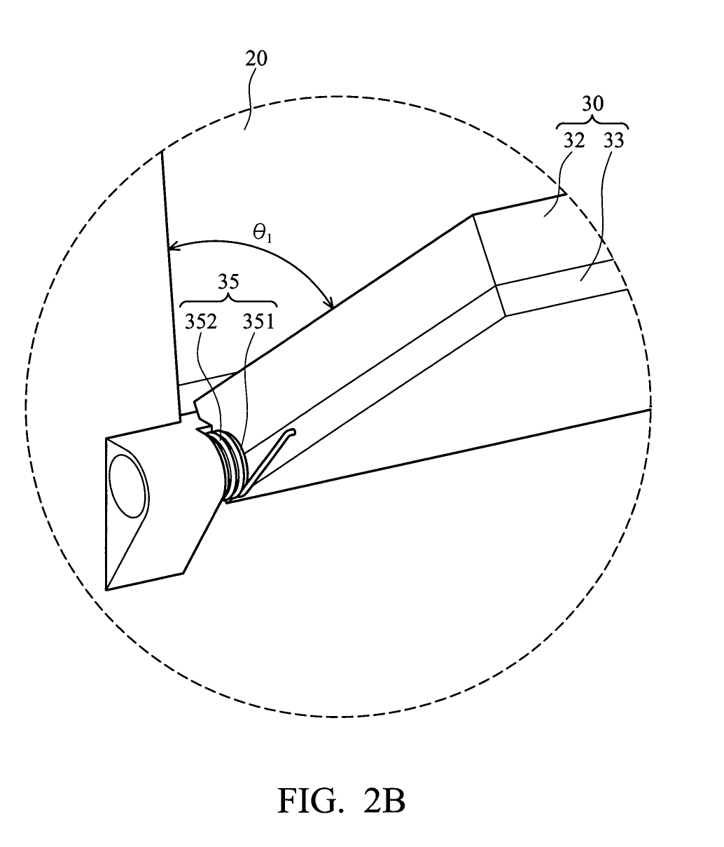

FIG. 2A is a schematic view of an embodiment of a scanner 100. The improved scanners in an upright or hung position are described herein. The scanner 100 can scan objects 50 such as books, documents, photos, and negatives. As shown in FIG. 2A, the scanner 100 comprises a main body 20, a cover 40, and a positioning mechanism 30. The cover 40 is rotatably disposed on the main body 20. The positioning mechanism 30 is disposed on the main body 20 and the cover 40. When the cover 40 is open and the object 50 is disposed between the main body 20 and the cover 40, the object 50 is maintained on a scanning area 22 of the main body 20 by the positioning mechanism 30. When the cover 40 is closed on the main body 20, the cover 40 forces the positioning mechanism 30 to press on the object 50 such that the object 50 is abutted on the main body 20.

In detail, the positioning mechanism 30 comprises a first blocking piece 33, a first elastic structure 35, a first pad 32, and a second pad 34. The first pad 32 and the second pad 34 comprise sponge, rubber or other soft materials. The first elastic structure 35 connects the main body 20 and the first blocking piece 33. When the cover 40 is open, the first elastic structure 35 tilts the first blocking piece 33 at a first angle θ₁ with respect to the main body 20. Note that the first angle θ₁ is determined by the first elastic structure 35. The first pad 32 is disposed on the first blocking piece 33. The second pad 34 is disposed on the cover 40. The cover 40 comprises a corresponding region 42, and when the cover 40 is closed on the main body 20, the first pad 32 is disposed on the corresponding region 42 of the cover 40. The total thickness of the first pad 32 and the first blocking piece 33 can be substantially the same as that of the second pad 34 such that when the cover 40 is closed on the main body 20, the first pad 32 and the second pad 34 substantially contact the same side of the object 50. That is, the first pad 32 and the second pad 34 completely cover the scanning area 22 of the main body 20.

FIG. 2B is a local enlarged view of a first elastic structure 35 of FIG. 2A. The first elastic structure 35 comprises a pivoting structure 351 and an elastic element 352, encircling the pivoting structure 351. The elastic element 352 comprises a spring, and the pivoting structure comprises a hinge. Thus, when the cover 40 is open, the first blocking piece 33 is tilted up by the first elastic structure 35 at an appropriate angle, the first angle θ₁, such that the first blocking piece 33 can support the object 50, preventing it from falling off the scanner.

In a varied embodiment, the first elastic structure 35 can comprise a pair of elastic structures, disposed on both ends of the first blocking piece 33.

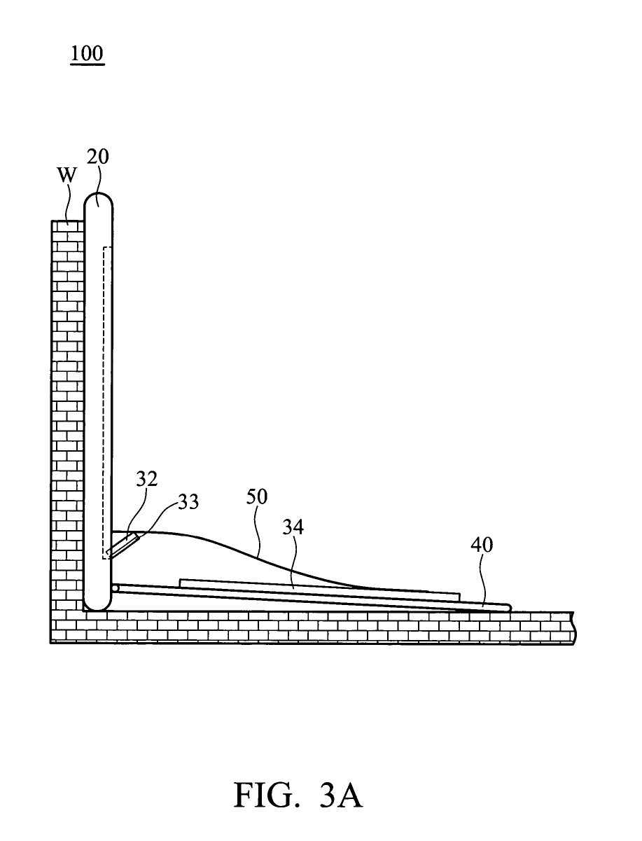

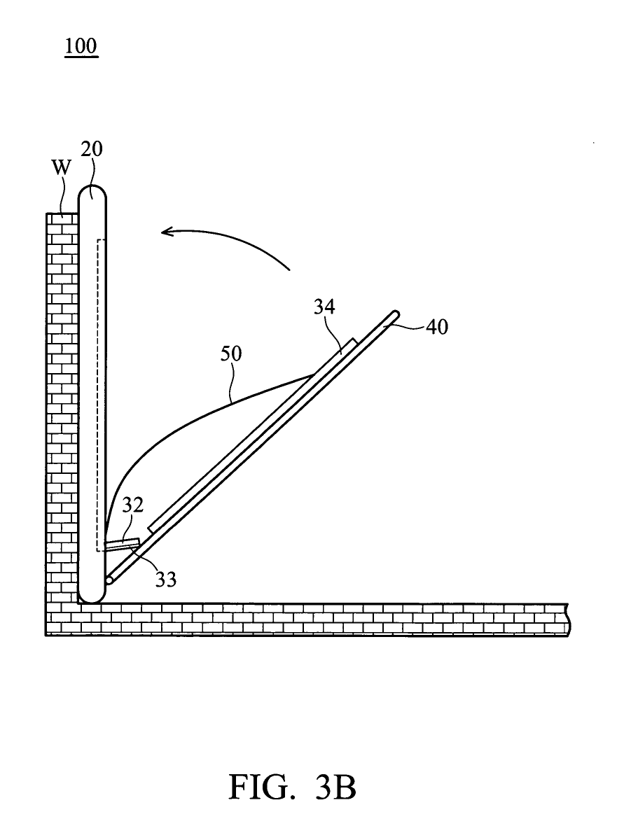

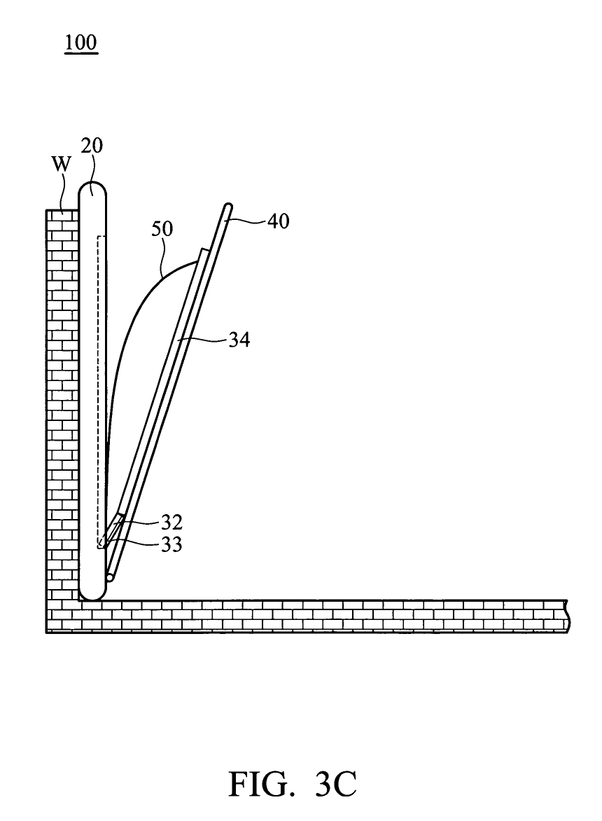

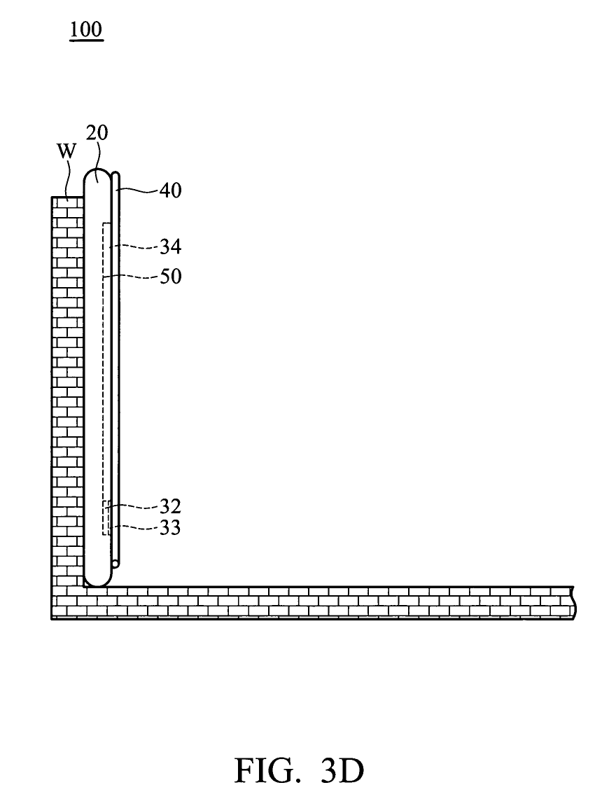

FIGS. 3A to 3D are schematic views of continuous motions of cover 40 of the scanner 100. In the embodiment, the scanner 100 is at upright position, abutted at a sidewall W. Note that the scanner 100 can be an upright or hanging type.

When the cover 40 is completely open to scan the object 50, as shown in FIG. 3A, an end of the object 50 is disposed at the first blocking piece 33 and the first pad 32. The other end of the object 50 naturally slants to the second pad 34 of the cover 40. When the cover 40 is moved toward the main body 20, as shown in FIGS. 3B and 3C, the object 50 is naturally curved due to gravity. Since the positioning mechanism 30 has blocking pieces, the object 50 does not fall off and is kept in contact with the scanning area 22. When the cover 40 is closed on the main body 20, as shown in FIG. 3D, the cover 40 and the second pad 34 thereon force the first blocking piece 33 of the positioning mechanism 30 to press on the object 50. Note that the total thickness of the first blocking piece 33 and the first pad 32 is substantially equal to that of the second pad 34, and when the cover 40 makes the first blocking piece 33 is pressed toward the main body 20, the first blocking piece 33 and the second pad 34 on the cover 40 are aligned without interfering with each other. Thus, the positioning mechanism 30 can position the object 50 and is pressed flat between the cover 40 and the main body 20 for scanning.

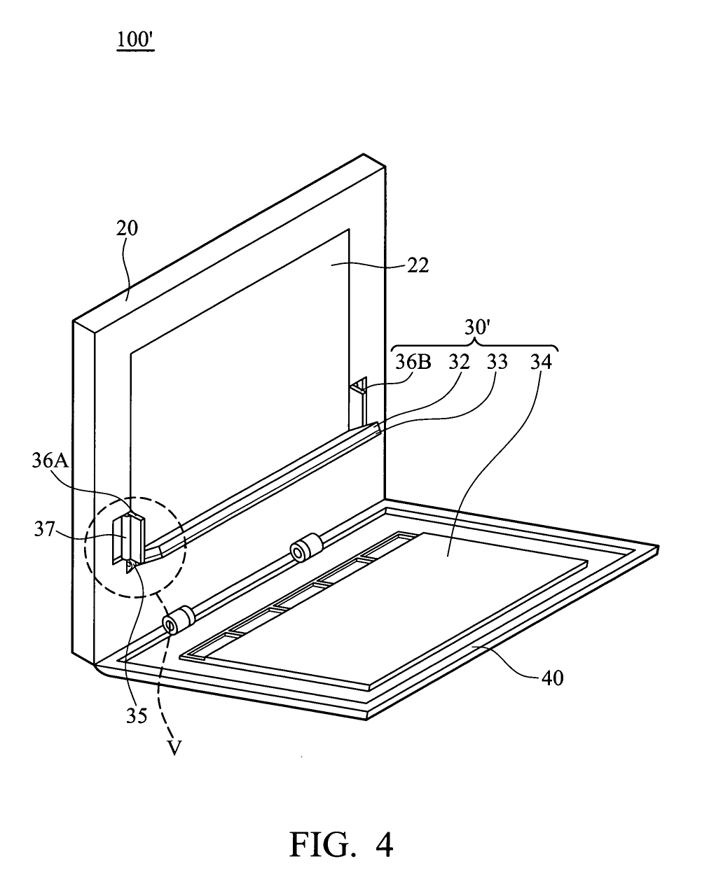

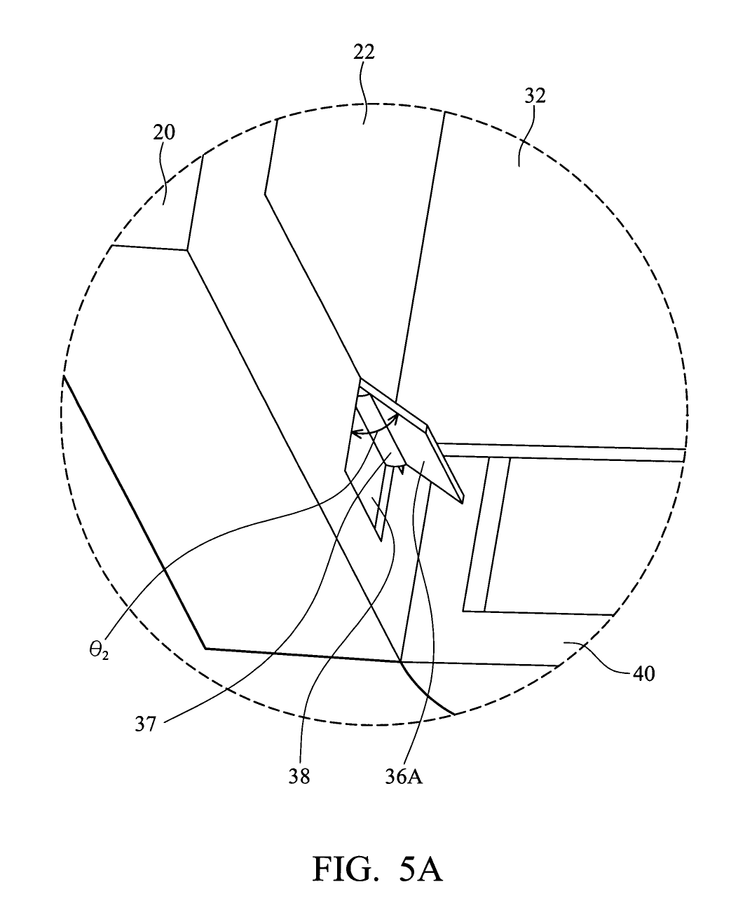

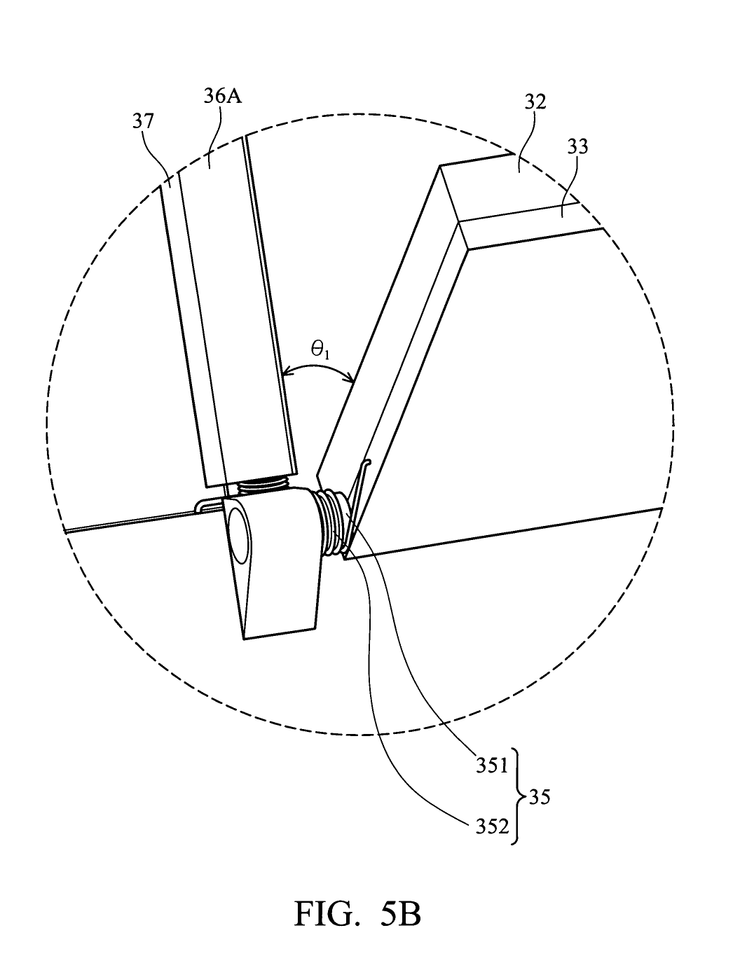

FIG. 4 is a schematic view of another embodiment of a scanner 100′. The difference from the above embodiment is that the main body 20 comprises a pair of depressions 38, as shown in FIG. 5A, in which the same elements are provided with the same symbols. The positioning mechanism 30′ comprises a first blocking piece 33, a first elastic structure 35, a second blocking piece 36A, a third blocking piece 36B, a pair of second elastic structures 37, a first pad 32, and a second pad 34. The second blocking piece 36A and the third blocking piece 36B are disposed in the vicinity of two ends of the first blocking piece 33, and correspond to the depressions 38 of the main body 20, respectively. When the cover 40 is closed on the main body 20, the second blocking piece 36A and the third blocking piece 36B are disposed in the depressions 38. The first blocking piece 33 is substantially perpendicular to the second blocking piece 36A and the third blocking piece 36B. Thus, the first blocking piece 33 and the second and third blocking pieces 36A and 36B are substantially arranged in a U-shape.

FIGS. 5A and 5B are local enlarged views of a portion V of FIG. 4 in different views. Note that FIGS. 5A and 5B only show a local enlarged view of the second blocking piece 36A. The third blocking piece 36B is symmetrical to the second blocking piece 36A, having the same structure as the second blocking piece 36A, and thus, further explanation is omitted. The first elastic structure 36 connects main body 20 and the first blocking piece 33. When the cover 40 is open, the first elastic structure 35 tilts the first blocking piece 33 at a first angle θ₁ with respect to the main body 20, as shown in FIG. 5B. In FIG. 5A, the second elastic structure 37 connects the second blocking piece 36A and the main body 20. When the cover 40 is open, the second elastic structure 37 tilts the second blocking piece 36A at a second angle θ₂ with respect to the main body 20, preventing an object from falling down a side of the main body 20.

Moreover, the first and the second elastic structures 35 and 37, each of which comprises a pivoting structure and an elastic element, encircling the pivoting structure. In this embodiment, the elastic element comprises a spring. The pivoting structure comprises a hinge.

In conclusion, the scanners of the invention can prevent object from falling down the scanning area. The object is correctly positioned via a simple design. Additionally, the invention offers easier assembly, provides a compact scanner, and reduces manufacturing costs.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded with the broadest interpretation so as to encompass all such modifications and similar arrangements.

What is claimed is:

1. A scanner for scanning an object, comprising:
a main body;
a cover, rotatably connected to the main body; and
a positioning mechanism, disposed on the main body and the cover; wherein when the cover is open and the object is disposed between the main body and the cover, the object is maintained thereon by the positioning mechanism, and when the cover is closed, the cover forces the positioning mechanism to press on the object such that the object is abutted on the main body.

2. The scanner as claimed in claim 1, wherein the positioning mechanism comprises a first blocking piece and a first elastic structure, connecting the main body and the first blocking piece; when the cover is open, the first elastic structure tilts the first blocking piece at a first angle with respect to the main body.

3. The scanner as claimed in claim 2, wherein the first elastic structure comprises a pivoting structure and an elastic element, encircling the pivoting structure.

4. The scanner as claimed in claim 3, wherein the elastic element comprises a torsional spring.

5. The scanner as claimed in claim 2, wherein the positioning mechanism further comprises a first pad, disposed on the first blocking piece, and a second pad, disposed on the cover; when the cover is closed on the main body, the first pad and the second pad substantially contact the same side of the object.

6. The scanner as claimed in claim 5, wherein the main body comprises a scanning area; when the cover is closed on the main body, the first pad and the second pad completely cover the scanning area of the main body.

7. The scanner as claimed in claim 5, wherein the first pad and the second pad comprise sponge.

8. The scanner as claimed in claim 1, wherein the positioning mechanism comprises a second blocking piece and a second elastic structure connecting the second blocking piece and the main body; when the cover is open, the second elastic structure tilts the second blocking piece at a second angle with respect to the main body, preventing the object from falling down a side of the main body.

9. The scanner as claimed in claim 8, wherein the blocking mechanism further comprises a first blocking piece, substantially perpendicular to the second blocking piece, and a first elastic structure, connecting the main body and the first blocking piece; when the cover is open, the first elastic structure tilts the first blocking piece at a first angle with respect to the main body.

10. The scanner as claimed in claim 8, wherein the positioning mechanism further comprises a third blocking piece, symmetrical to the second blocking piece, and a third elastic structure disposed on an opposite side of the main body and connecting the third blocking piece and the main body; when the cover is open, the third elastic structure tilts the third blocking piece at a third angle with respect to the main body, preventing the object from falling down the opposite side.

11. The scanner as claimed in claim 8, wherein the second elastic structure comprises a pivoting structure and an elastic element, encircling the pivoting structure.

12. The scanner as claimed in claim 11, wherein the elastic element comprises a torsional spring.

13. The scanner as claimed in claim 1, wherein the positioning mechanism comprises a first blocking piece and a pair of second blocking pieces, disposed in the vicinity of two ends of the first blocking piece; the first blocking piece and the second blocking piece are substantially arranged in a U-shape.

14. The scanner as claimed in claim 1, wherein the scanner comprises an upright-type scanner.
